(19) United States
(12) Patent Application Publication
(10) Pub. No.: US 2022/0172267 A1
(43) Pub. Date: Jun. 2, 2022

(54) ONLINE CUSTOMER SERVING SYSTEM AND TERMINAL DEVICE

(71) Applicant: LIXIL Corporation, Tokyo (JP)

(72) Inventors: Yumiko HASHIMOTO, Tokyo (JP); Hiroto KOJIMA, Tokyo (JP)

(73) Assignee: LIXIL Corporation, Tokyo (JP)

(21) Appl. No.: 17/538,768

(22) Filed: Nov. 30, 2021

(30) Foreign Application Priority Data
Dec. 2, 2020 (JP) 2020-200542

(51) Int. Cl. G06Q 30/06

(52) U.S. Cl. CPC G06Q 30/0613; G10L 15/22; G06Q 30/0643; G06Q 30/0623

(57) ABSTRACT

An online customer serving system includes a customer terminal to be used by a customer, a contact person's terminal to be used by a contact person who serves the customer, and the Internet as a communication means to be used for communication between the customer terminal and the contact person's terminal. The contact person's terminal includes a product information provider that provides, to the customer terminal, information regarding a product selected based on a request from the customer. The customer terminal includes a product information display unit that displays, on a first display device, information regarding a product transmitted from the contact person's terminal.

### CROSS-REFERENCE TO RELATED APPLICATIONS

This application claims the priority of JP Application No. 2020-200542, filed Dec. 2, 2020.

### FIELD OF THE DISCLOSURE

The present disclosure relates to an online customer serving system and a terminal device used to serve customers online.

### DESCRIPTION OF THE DISCLOSURE

In various fields including furniture, home appliances, and building components, showrooms are opened to introduce products to customers. In a showroom, customers can actually have various products in their hands and check the product operation, so that the customers can efficiently find their desired products. Also, the business running the showroom can directly receive requests from the customers and introduce products that meet the requests, so that the business can efficiently make a contract and also can make use of the customers' opinions for product development and sales strategies.

However, upon spread of the novel coronavirus infection, closure of showrooms or reduction of opening hours has been necessitated. To overcome such a situation, the inventors have considered that there is a need to introduce, instead of a system for automatically distributing information, such as the virtual exhibition hall system described in Patent Literature 1 (Japanese Unexamined Patent Application Publication No. 2007-65752), a system for enabling a contact person to thoughtfully serve a customer without meeting the customer.

### SUMMARY OF THE DISCLOSURE

The present disclosure has been made in view of such an issue, and a purpose thereof is to provide a technology for enabling serving a customer online.

In response to the above issue, an online customer serving system according to some embodiments of the present disclosure include a customer terminal to be used by a customer, a contact person's terminal to be used by a contact person who serves the customer, and a communication means to be used for communication between the customer terminal and the contact person's terminal. The customer terminal includes: a first input device that receives voice of the customer; a first audio transmitter that transmits, to the contact person's terminal, audio input by the first input device; a first image receiver that receives an image transmitted from the contact person's terminal; a first display device that displays an image received by the first image receiver; a first audio receiver that receives audio transmitted from the contact person's terminal; and a first audio output device that outputs audio received by the first audio receiver. The contact person's terminal includes: an imaging device that captures an image; a second image transmitter that transmits an image captured by the imaging device to the customer terminal; a second input device that receives voice of the contact person; a second audio transmitter that transmits, to the customer terminal, audio input by the second input device; a second audio receiver that receives audio transmitted from the customer terminal; and a second audio output device that outputs audio received by the second audio receiver. The contact person's terminal further includes a product information provider that provides, to the customer terminal, information regarding a product selected based on a request from the customer. The customer terminal further includes a product information display unit that displays, on the first display device, information regarding a product transmitted from the contact person's terminal.

In some embodiments, a terminal device is included. The device is a terminal device to be used by a contact person who serves a customer. The terminal device includes: an imaging device that captures an image; an image transmitter that transmits an image captured by the imaging device to a customer terminal; an input device that receives voice of the contact person; an audio transmitter that transmits, to the customer terminal, audio input by the input device; an audio receiver that receives audio transmitted from the customer terminal; an audio output device that outputs audio received by the audio receiver; and a product information provider that provides, to the customer terminal, information regarding a product selected based on a request from the customer.

Optional combinations of the aforementioned constituting elements, and implementation of the present disclosure in the form of methods, apparatuses, systems, recording media, and computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 schematically illustrates a configuration of an online customer serving system, according to some embodiments;

FIG. 2 is a sequential diagram that shows a procedure of a method for online customer serving, according to some embodiments;

FIG. 3 illustrates a configuration of a contact person's terminal, according to some embodiments;

FIG. 4 illustrates a configuration of a customer terminal, according to some embodiments;

FIG. 5 shows an example of a screen presented on the customer terminal in the online customer serving system, according to some embodiments; and

FIG. 6 shows an example of another screen presented on the customer terminal in the online customer serving system, according to some embodiments.

### DETAILED DESCRIPTION OF THE DISCLOSURE

The disclosure will now be described by reference to various embodiments. This does not intend to limit the scope of the present disclosure, but to exemplify the invention.

In some embodiments, an online customer serving system for enabling serving a customer online will be disclosed. The online customer serving system according to some embodiments provides a function to enable conversation between a customer terminal used by a customer and a contact person's terminal used by a contact person who serves the customer, while each of the customer and the contact person watches video of the opposite party. Accordingly, the contact person can receive requests from the customer and introduce a product suitable for the customer and also can read the reaction on the customer's face or the like, in the same way as when the contact person meets and serves the customer in person in a showroom or the like. Also, customer services available only online, which are different from those provided to customers in person in a showroom, can be provided to customers. For example, a customer can view a moving image for introducing a product and also can use a tool or system online to search for a product suitable for the customer. Also, when a customer is present in a place where a product is to be used or installed and when the customer can capture and transmit an image of the place to a contact person's terminal, the contact person can check the place where the product is to be actually used or installed and propose an appropriate product. Thus, the online customer serving system of the present embodiment provides a novel place for serving customers that not only can substitute for serving customers in showrooms or the like but also can further improve the customers' convenience, enabling increase in the contract completion rate.

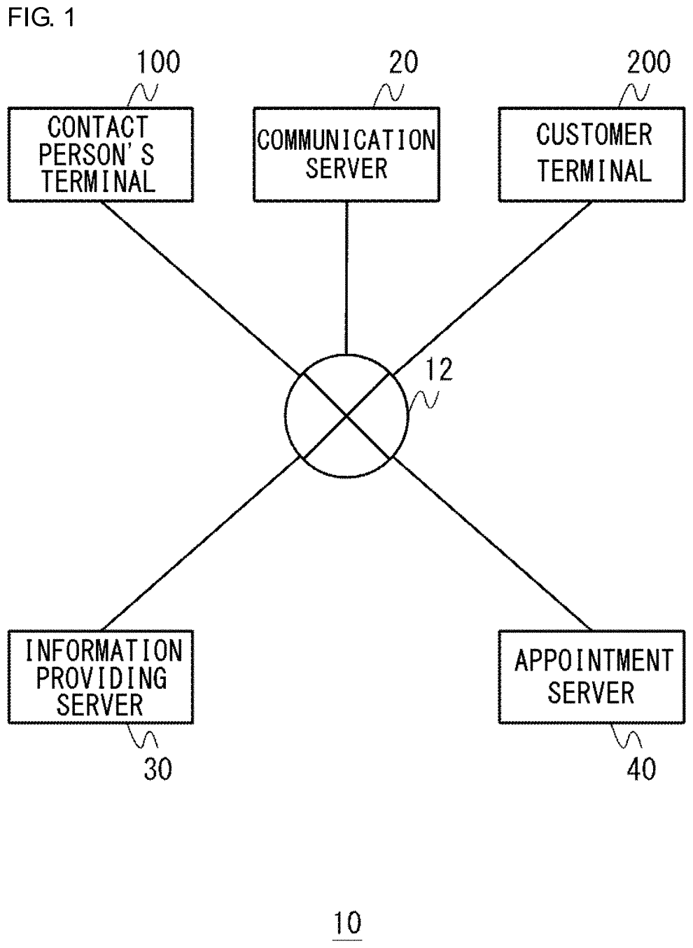

FIG. 1 schematically illustrates a configuration of an online customer serving system according to some embodiments. An online customer serving system 10 includes a contact person's terminal 100, a customer terminal 200, a communication server 20, an information providing server 30, an appointment server 40, and the Internet 12, which serves as an example of a communication network that connects these terminals and servers.

The communication server 20 mediates transmission of image data and audio data between the contact person's terminal 100 and the customer terminal 200 and also provides a video chat function. The communication server 20 may have functions provided in general video chat services, such as turning on and off of image transmission, turning on and off of audio transmission, screen sharing, and file sharing.

The contact person's terminal 100 captures an image of a contact person to transmit it to the customer terminal 200 and also receives voice of the contact person to transmit it to the customer terminal 200. Also, the contact person's terminal 100 displays, on a display device, an image of a customer received from the customer terminal 200 and also outputs, to a speaker, the voice of the customer received from the customer terminal 200. Based on an instruction entered by the contact person, the contact person's terminal 100 provides information regarding a product, an image, a moving image, and the like to the customer terminal 200. The contact person's terminal 100 may be placed in a showroom where products are exhibited. In this case, the contact person can carry the contact person's terminal 100 and walk around in the showroom to introduce products exhibited in the showroom to customers. The contact person's terminal 100 may be placed in an office or a center besides a showroom or may be placed in the contact person's house.

One contact person may serve a customer, or multiple contact persons may serve a customer. In the latter case, the multiple contact persons may use the same contact person's terminal 100 to join the online customer serving system 10 or may use the respective contact person's terminals 100 to join the online customer serving system 10. Accordingly, the customer can be served more hospitably. Also, while the main contact person is serving the customer, another contact person may take the minutes, check the screen, or answer the customer's question for the main contact person.

The customer terminal 200 captures an image of a customer to transmit it to the contact person's terminal 100 and also receives voice of the customer to transmit it to the contact person's terminal 100. Also, the customer terminal 200 displays, on a display device, an image of a contact person received from the contact person's terminal 100 and also outputs, to a speaker, the voice of the contact person received from the contact person's terminal 100. The configuration of capturing an image of a customer to transmit it to the contact person's terminal 100 may be omitted. The customer terminal 200 may be a personal computer placed in the customer's house or may be a mobile terminal carried by the customer. With the online customer serving system 10 of the embodiment, a customer staying in the customer's house can be served by a contact person present in a showroom or an office, or a customer visiting a showroom can be served by a contact person present in an office or the contact person's house while the customer can check the exhibited products.

The information providing server 30 provides information regarding products. The information providing server 30 retains the specification, features, price, shape data, an image, a moving image, and the like of each product and provides information upon request from the contact person's terminal 100 or the customer terminal 200. The information providing server 30 provides a tool or service used to search for a desired product, and a tool or service used to prepare an estimate of a product.

The appointment server 40 accepts from the customer terminal 200 an appointment made by a customer via the online customer serving system 10 to get served by a contact person at a given date and time. The appointment server 40 may accept an appointment to get served by a contact person who belongs to a showroom located closer to the customer's residence. In this case, when visiting the showroom, the customer can get served by the same contact person, so that the customer's convenience can be improved. The appointment server 40 may also accept an appointment to get served by a contact person who belongs to an arbitrary showroom or customer service center, irrespective of the customer's residence. In this case, a free contact person can be made to efficiently work to serve the customer. With the online customer serving system 10 of the present embodiment, since a customer can be served irrespective of the opening hours of a showroom or the like, the appointment server 40 may accept an early morning appointment or a nighttime appointment, for example.

Upon accepting an appointment, the appointment server 40 transmits to the customer terminal 200 an interview sheet into which the customer's personal information, such as the name, age, and gender, and the customer's requests regarding a product, for example, are to be entered. Accordingly, the customer fills out the interview sheet and returns it via the customer terminal 200 to the appointment server 40 by the appointment date and time. The appointment server 40 then transmits, to the contact person's terminal 100, the interview sheet acquired from the customer terminal 200 and the appointment date and time.

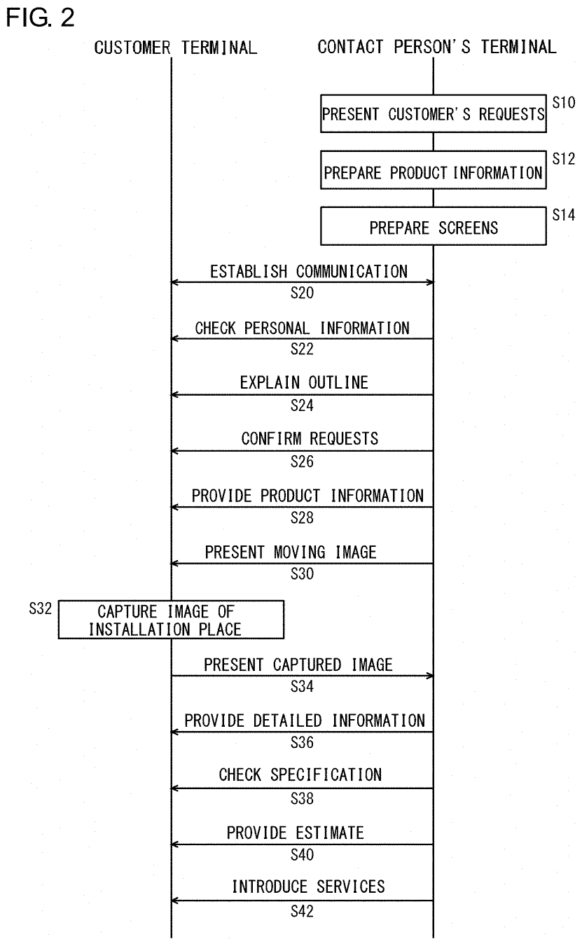

FIG. 2 is a sequential diagram that shows a procedure of a method for online customer serving according to some embodiments. The contact person's terminal 100 presents, to a contact person, the interview sheet acquired from the customer terminal 200 (S10). The interview sheet may be acquired from the customer terminal 200 via the appointment server 40 or the like or may be acquired directly from the customer terminal 200. Accordingly, the contact person selects a product that meets the customer's requests and prepares information regarding the selected product to store the information in a storage device of the contact person's terminal 100 (S12). Also, the contact person creates screens to be presented on the customer terminal 200 before the online customer serving is started, when the online customer serving is started, during the online customer serving, and when the online customer serving is finished, for example, and stores the screens in the storage device of the contact person's terminal 100 (S14).

At the appointment date and time, which the appointment server 40 has accepted from the customer terminal 200, each of the contact person's terminal 100 and the customer terminal 200 connects to the communication server 20 to establish communication (S20). The contact person operates the contact person's terminal 100 to present the personal information of the customer on the customer terminal 200 and asks the customer to check for mistakes; if there is a mistake, the contact person corrects the mistake (S22). The contact person explains the outline of the online customer serving, such as the procedures and the estimated finish time, to the customer and obtains consent from the customer (S24). The contact person operates the contact person's terminal 100 to present the interview sheet of the customer on the customer terminal 200 and confirms the customer's requests (S26). Therefore, the contact person can precisely grasp the customer's requests and construct the explanation of the product accordingly.

The contact person provides, from the contact person's terminal 100 to the customer terminal 200, information of a product that meets the customer's requests (S28). The contact person also operates the contact person's terminal 100 to present a moving image for introducing the product on the customer terminal 200 (S30).

When the customer is present in a place where the product is to be used or installed, the customer may capture an image of the place using an imaging device (S32) and may transmit the captured image from the customer terminal 200 to the contact person's terminal 100 (S34). Accordingly, since the contact person can check the place where the product is to be actually used or installed, the contact person can propose a product that meets the customer's requests more suitably. The customer may measure the dimensions of the place where the product is to be used or installed and transmit the dimensions to the contact person's terminal 100. Such dimensions may also be automatically calculated based on the image of the place where the product is to be used or installed. Accordingly, the contact person can select and propose a product that can be used or installed in the place.

The contact person uses a tool or service provided by the information providing server 30 to narrow down the products suitable for the customer and provides detailed information of a product to the customer terminal 200 (S36). With the customer, the contact person discusses the type and specification of a product suitable for the customer and checks the details of the product (S38). The contact person prepares an estimate of the product suitable for the customer using an estimate preparation tool provided by the information providing server 30 or the like and provides the estimate from the contact person's terminal 100 to the customer terminal 200 (S40). The contact person provides, to the customer terminal 200, a tool that can be used in the customer's house so that the customer can further obtain information regarding the product, and information regarding services and campaigns available for the customer (S42).

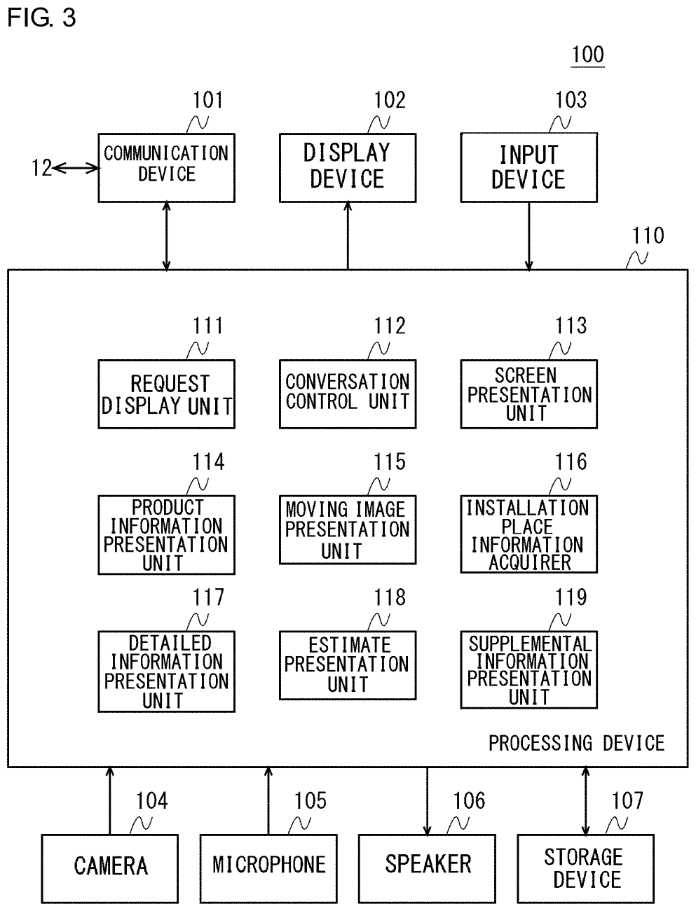

FIG. 3 illustrates a configuration of the contact person's terminal 100 according to some embodiments. The contact person's terminal 100 includes a communication device 101, a display device 102, an input device 103, a camera 104, a microphone 105, a speaker 106, a storage device 107, and a processing device 110. The contact person's terminal 100 may be a server device, a personal computer, or other devices, or may be a mobile terminal, such as a cellular phone terminal, a smartphone, and a tablet terminal.

The communication device 101 controls communication with other devices. The communication device 101 may perform communication using an arbitrary wired or wireless communication scheme. The display device 102 displays a screen generated by the processing device 110. The display device 102 may be a liquid crystal display device, an organic EL display device, or the like. The input device 103 transmits, to the processing device 110, an instruction entered by a contact person. The input device 103 may be a mouse, a keyboard, a touch pad, or the like. The display device 102 and the input device 103 may be implemented as a touch panel.

The camera 104 captures an image. The camera 104 is installed such as to capture an image of the contact person's face. The microphone 105 inputs audio. The microphone 105 is installed such as to receive the contact person's voice. The speaker 106 outputs audio. The speaker 106 outputs the customer's voice received from the customer terminal 200.

The storage device 107 stores programs, data, and the like used by the processing device 110. The storage device 107 may be semiconductor memory, a hard disk, or the like. The storage device 107 stores the data of the interview sheet filled out by the customer, information regarding a product prepared in advance by the contact person, the data of screens presented on the customer terminal 200, and the like.

The processing device 110 includes a request display unit 111, a conversation control unit 112, a screen presentation unit 113, a product information presentation unit 114, a moving image presentation unit 115, an installation place information acquirer 116, a detailed information presentation unit 117, an estimate presentation unit 118, and a supplemental information presentation unit 119. Each of these configurations may be implemented by a circuit, a CPU, or memory of any given computer, an LSI, or the like in terms of hardware, and by a memory-loaded program or the like in terms of software. In the present embodiments are shown functional blocks realized by cooperation thereof. Therefore, it will be understood by those skilled in the art that these functional blocks may be implemented in a variety of forms by hardware only, a combination of hardware and software, or the like.

The request display unit 111 stores, in the storage device 107, the interview sheet acquired from the customer terminal 200. Based on an instruction input from the input device 103, the request display unit 111 retrieves the interview sheet from the storage device 107 and displays the interview sheet on the display device 102 (S10).

At the appointment date and time, which the appointment server 40 has accepted from the customer terminal 200, the conversation control unit 112 connects to the communication server 20 to establish communication with the customer terminal 200 (S20). During the online customer serving, the conversation control unit 112 transmits, to the customer terminal 200, an image of the contact person captured by the camera 104 and also the voice of the contact person received by the microphone 105. Also, the conversation control unit 112 displays, on the display device 102, an image of the customer received from the customer terminal 200 and also outputs, to the speaker 106, the voice of the customer received from the customer terminal 200.

Based on an instruction input from the input device 103, the screen presentation unit 113 retrieves screen data stored in the storage device 107 and displays the screen data on the display device 102. When the screen sharing function is turned on, the conversation control unit 112 transmits the screen data displayed on the display device 102 to the customer terminal 200. Accordingly, the screen is presented on the customer terminal 200. For example, the screen presentation unit 113 presents personal information of the customer on the customer terminal 200 to ask the customer to check for mistakes (S22), presents the outline of the online customer serving to the customer (S24), and presents the interview sheet of the customer on the customer terminal 200 to confirm the customer's requests (S26).

The product information presentation unit 114 presents, on the customer terminal 200, information of a product that meets the customer's requests (S28). The moving image presentation unit 115 presents a moving image for introducing the product on the customer terminal 200 (S30).

The installation place information acquirer 116 acquires, from the customer terminal 200, information regarding a place where the customer is to use or install the product. When the customer is present in the place where the product is to be used or installed, the installation place information acquirer 116 acquires a captured image of the place from the customer terminal 200 (S34). The installation place information acquirer 116 may acquire, from the customer terminal 200, the dimensions of the place where the product is to be used or installed.

The detailed information presentation unit 117 presents, on the customer terminal 200, detailed information of a product to which the products have been narrowed down using a tool or service provided by the information providing server 30 (S36). The estimate presentation unit 118 presents an estimate of a product suitable for the customer on the customer terminal 200 (S40). The supplemental information presentation unit 119 presents, on the customer terminal 200, a tool that can be used in the customer's house so that the customer can further obtain information regarding a product, and information regarding services and campaigns available for the customer (S42).

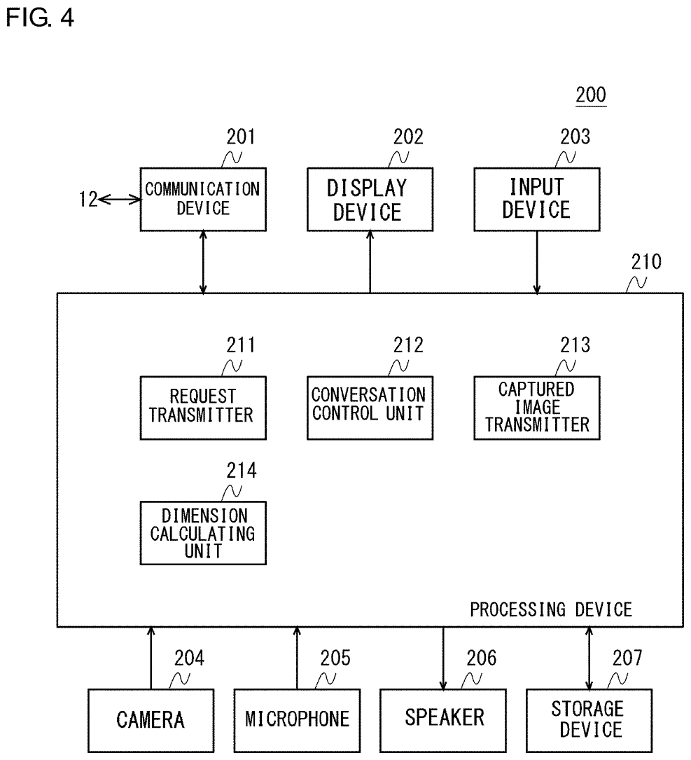

FIG. 4 illustrates a configuration of the customer terminal 200 according to some embodiments. The customer terminal 200 includes a communication device 201, a display device 202, an input device 203, a camera 204, a microphone 205, a speaker 206, a storage device 207, and a processing device 210. The customer terminal 200 may be a personal computer or other devices or may be a mobile terminal, such as a cellular phone terminal, a smartphone, and a tablet terminal.

The communication device 201 controls communication with other devices. The communication device 201 may perform communication using an arbitrary wired or wireless communication scheme. The display device 202 displays a screen generated by the processing device 210. The display device 202 may be a liquid crystal display device, an organic EL display device, or the like. The input device 203 transmits, to the processing device 210, an instruction entered by a contact person. The input device 203 may be a mouse, a keyboard, a touch pad, or the like. The display device 202 and the input device 203 may be implemented as a touch panel.

The camera 204 captures an image. The camera 204 is installed such as to capture an image of the customer's face. The microphone 205 inputs audio. The microphone 205 is installed such as to receive the customer's voice. The speaker 206 outputs audio. The speaker 206 outputs the contact person's voice received from the contact person's terminal 100.

The storage device 207 stores programs, data, and the like used by the processing device 210. The storage device 207 may be semiconductor memory, a hard disk, or the like. The storage device 107 stores the data of the interview sheet filled out by the customer.

The processing device 210 includes a request transmitter 211, a conversation control unit 212, a captured image transmitter 213, and a dimension calculating unit 214. These configurations may also be implemented in a variety of forms by hardware only, a combination of hardware and software, or the like.

The request transmitter 211 receives, from the input device 203, information entered in the interview sheet acquired from the appointment server 40 and stores the information in the storage device 207. Based on an instruction input from the input device 203, the request transmitter 211 retrieves the completed interview sheet from the storage device 207 and transmits the interview sheet to the contact person's terminal 100 (S10).

At the appointment date and time, which the appointment server 40 has accepted from the customer terminal 200, the conversation control unit 212 connects to the communication server 20 to establish communication with the contact person's terminal 100 (S20). During the online customer serving, the conversation control unit 212 transmits, to the contact person's terminal 100, an image of the customer captured by the camera 204 and also the voice of the customer received by the microphone 205. Also, the conversation control unit 212 displays, on the display device 202, an image of the contact person received from the contact person's terminal 100 and also outputs, to the speaker 206, the voice of the contact person received from the contact person's terminal 100. The conversation control unit 212 functions as a product information display unit that displays, on the display device 202, information regarding a product transmitted from the contact person's terminal 100.

The captured image transmitter 213 transmits, to the contact person's terminal 100, an image of a place where the customer is to use or install the product, captured by the camera 204 (S32, S34). The dimension calculating unit 214 calculates the dimensions of the place where the product is to be used or installed and transmits the dimensions to the contact person's terminal 100.

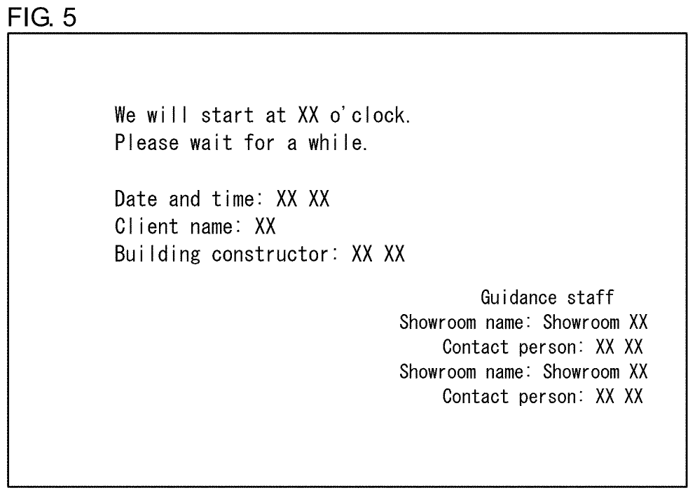

FIG. 5 shows an example of a screen presented on the customer terminal 200 in the online customer serving system 10 according to some embodiments. FIG. 5 shows a standby screen presented on the customer terminal 200 before the appointment date and time arrives. The contact person's terminal 100 presents a standby screen created by the contact person on the customer terminal 200.

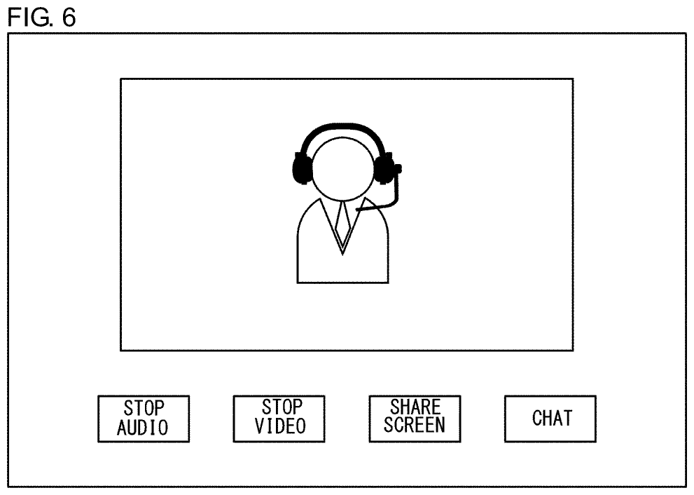

FIG. 6 shows an example of another screen presented on the customer terminal 200 in the online customer serving system 10 according to some embodiments. FIG. 6 shows a conversation screen presented on the customer terminal 200 after the appointment date and time has arrived. The contact person's terminal 100 transmits an image of the contact person captured by the camera 104 to the customer terminal 200. Using the screen sharing function, the contact person's terminal 100 presents, on the customer terminal 200, information regarding a product, a moving image, detailed information, an estimate, supplemental information, and the like.

The present invention has been described with reference to various embodiments, which merely describes principles and applications of the present disclosure. Also, various modifications or changes in arrangement may be made to some embodiments without departing from the scope of ideas of the present disclosure defined in the claims.

1. An online customer serving system, comprising:
a customer terminal to be used by a customer;
a contact person's terminal to be used by a contact person who serves the customer; and
a communication means to be used for communication between the customer terminal and the contact person's terminal,
the customer terminal comprising:
a first input device that receives voice of the customer;
a first audio transmitter that transmits, to the contact person's terminal, audio input by the first input device;
a first image receiver that receives an image transmitted from the contact person's terminal;
a first display device that displays an image received by the first image receiver;
a first audio receiver that receives audio transmitted from the contact person's terminal; and
a first audio output device that outputs audio received by the first audio receiver,
the contact person's terminal comprising:
an imaging device that captures an image;
a second image transmitter that transmits an image captured by the imaging device to the customer terminal;
a second input device that receives voice of the contact person;
a second audio transmitter that transmits, to the customer terminal, audio input by the second input device;
a second audio receiver that receives audio transmitted from the customer terminal; and
a second audio output device that outputs audio received by the second audio receiver,
the contact person's terminal further comprising a product information provider that provides, to the customer terminal, information regarding a product selected based on a request from the customer, and
the customer terminal further comprising a product information display unit that displays, on the first display device, information regarding a product transmitted from the contact person's terminal.

2. The online customer serving system of claim 1, wherein the contact person's terminal further comprises a request presentation unit that presents, to the contact person, a request regarding the product received in advance from the customer.

3. The online customer serving system of claim 1, wherein the contact person's terminal further comprises a second image display unit that acquires, from the customer terminal, an image of a place where the product is to be used or installed by the customer and that displays the image on a second display device.

4. The online customer serving system of claim 1, wherein the contact person's terminal further comprises a moving image distribution unit that displays a moving image regarding the product on the first display device of the customer terminal.

5. The online customer serving system of claim 1, wherein the contact person's terminal further comprises a detailed information provider that provides, to the customer terminal, detailed information referred to by the customer to examine the specification of the product.

6. The online customer serving system of claim 1, wherein the contact person's terminal further comprises an estimate provider that prepares an estimate of the product and provides the estimate to the customer terminal.

7. The online customer serving system of claim 1, further comprising an appointment server that accepts from the customer an appointment made by the customer via the online customer serving system to get served by the contact person at a date and time, wherein
at the date and time of appointment that the appointment server has accepted from the customer, communication between the contact person's terminal and the customer terminal starts to be performed.

8. A terminal device to be used by a contact person who serves a customer, the terminal device comprising:
an imaging device that captures an image;
an image transmitter that transmits an image captured by the imaging device to a customer terminal;
an input device that receives voice of the contact person;
an audio transmitter that transmits, to the customer terminal, audio input by the input device;
an audio receiver that receives audio transmitted from the customer terminal;
an audio output device that outputs audio received by the audio receiver; and
a product information provider that provides, to the customer terminal, information regarding a product selected based on a request from the customer.

9. The online customer serving system of claim 2, wherein the contact person's terminal further comprises a second image display unit that acquires, from the customer terminal, an image of a place where the product is to be used or installed by the customer and that displays the image on a second display device.

10. The online customer serving system of claim 2, wherein the contact person's terminal further comprises a moving image distribution unit that displays a moving image regarding the product on the first display device of the customer terminal.

11. The online customer serving system of claim 3, wherein the contact person's terminal further comprises a moving image distribution unit that displays a moving image regarding the product on the first display device of the customer terminal.

12. The online customer serving system of claim 2, wherein the contact person's terminal further comprises a detailed information provider that provides, to the customer terminal, detailed information referred to by the customer to examine the specification of the product.

13. The online customer serving system of claim 3, wherein the contact person's terminal further comprises a detailed information provider that provides, to the customer terminal, detailed information referred to by the customer to examine the specification of the product.

14. The online customer serving system of claim 4, wherein the contact person's terminal further comprises a detailed information provider that provides, to the customer terminal, detailed information referred to by the customer to examine the specification of the product.

15. The online customer serving system of claim 2, wherein the contact person's terminal further comprises an estimate provider that prepares an estimate of the product and provides the estimate to the customer terminal.

16. The online customer serving system of claim 3, wherein the contact person's terminal further comprises an estimate provider that prepares an estimate of the product and provides the estimate to the customer terminal.

17. The online customer serving system of claim 4, wherein the contact person's terminal further comprises an estimate provider that prepares an estimate of the product and provides the estimate to the customer terminal.

18. The online customer serving system of claim 2, further comprising an appointment server that accepts from the customer an appointment made by the customer via the online customer serving system to get served by the contact person at a date and time, wherein
at the date and time of appointment that the appointment server has accepted from the customer, communication between the contact person's terminal and the customer terminal starts to be performed.

19. The online customer serving system of claim 3, further comprising an appointment server that accepts from the customer an appointment made by the customer via the online customer serving system to get served by the contact person at a date and time, wherein
at the date and time of appointment that the appointment server has accepted from the customer, communication between the contact person's terminal and the customer terminal starts to be performed.

20. The online customer serving system of claim 4, further comprising an appointment server that accepts from the customer an appointment made by the customer via the online customer serving system to get served by the contact person at a date and time, wherein
at the date and time of appointment that the appointment server has accepted from the customer, communication between the contact person's terminal and the customer terminal starts to be performed.
